(19) United States
(12) Patent Application Publication
(10) Pub. No.: US 2017/0134227 A1
(43) Pub. Date: May 11, 2017

(54) METHOD AND APPARATUS FOR TRANSMITTING AND RECEIVING DATA IN MESH NETWORK USING BLUETOOTH

(71) Applicant: LG ELECTRONICS INC., Seoul (KR)

(72) Inventors: Taeyoung SONG, Seoul (KR); Minsoo LEE, Seoul (KR); Younghwan KWON, Seoul (KR); Jinkwon LIM, Seoul (KR); Jingu CHOI, Seoul (KR)

(73) Assignee: LG ELECTRONICS INC., Seoul (KR)

(21) Appl. No.: 15/349,730

(22) Filed: Nov. 11, 2016

Related U.S. Application Data
(60) Provisional application No. 62/253,686, filed on Nov. 11, 2015.

(51) Int. Cl. H04L 12/24; H04W 52/02; H04W 4/00; H04L 5/00; H04L 1/18

(52) U.S. Cl. CPC H04L 41/0816; H04L 5/0055; H04L 1/1887; H04W 4/008; H04W 52/0216; H04W 88/04

(57) ABSTRACT

The present invention relates to a method and apparatus for transmitting and receiving a data packet in a Bluetooth mesh network performed by a node, the method includes participating in the Bluetooth mesh network; receiving a first data packet from a previous node in a relay state, where the relay state is a state for relaying the data packet in a flooding technique in the mesh network; and transmitting the first data packet to at least one adjacent node, where the first data packet includes information of number of times that represents a number of retransmission of the first data packet, where the relay state is maintained for a first specific time, and wherein the first specific time is determined based on the information of number of times.

### CROSS-REFERENCE TO RELATED APPLICATIONS

Pursuant to 35 U.S.C. §119(e), this application claims the benefit of U.S. Provisional Patent Application No. 62/253,686, filed on Nov. 11, 2015, the contents of which are hereby incorporated by reference herein in its entirety.

### BACKGROUND OF THE INVENTION

Field of the Invention

The present invention relates to a method and apparatus for transmitting and receiving data in a mesh network using the Bluetooth which is a short distance technique in wireless communication systems, and more particularly, to a method and apparatus for transmitting data to a destination through a relay node in a Bluetooth mesh network.

Discussion of the Related Art

Bluetooth is a short-range wireless technology standard that can wirelessly connect various types of devices and allows them to exchange data over short distances. To enable wireless communication between two devices using Bluetooth communication, a user has to perform the process of discovering Bluetooth devices to communicate with and making a connection request. As used herein, the term “device” refers to an appliance or equipment.

Here, the user may discover a Bluetooth device according to a Bluetooth communication method intended to be used using the Bluetooth device, and subsequently perform a connection.

The Bluetooth communication method may be classified as a BR/EDR method and an LE method. The BR/EDR method may be termed Bluetooth Classic. The Bluetooth Classic method includes a Bluetooth technology led from Bluetooth 1.0 and a Bluetooth technology using an enhanced data rate (EDR) supported by Bluetooth 2.0 or a subsequent version.

A Bluetooth low energy (LE) technology applied, starting from Bluetooth 4.0, may stably provide information of hundreds of kilobytes (KB) at low power consumption. Such a Bluetooth low energy technology allows devices to exchange information with each other by utilizing an attribute protocol. The Bluetooth LE method may reduce energy consumption by reducing overhead of a header and simplifying an operation.

Among the Bluetooth devices, some products do not have a display or a user interface. Complexity of connection, management, control, and disconnection among various types of Bluetooth devices and Bluetooth device employing similar technologies has increased.

Bluetooth supports a high speed at relatively low power consumption and at relatively low cost. However, since a transmission distance thereof is 100 m at the maximum, and thus, Bluetooth is appropriately used within a limited space.

### SUMMARY OF THE INVENTION

An object of the present invention is to provide a method and apparatus for transmitting and receiving data using a Bluetooth Low Energy (LE) technique.

In addition, another object of the present invention is to provide a method and apparatus for forming a mesh network using the Bluetooth.

In addition, still another object of the present invention is to provide a method and apparatus for transmitting and receiving data through a flooding technique or a routing technique in the mesh network using a Bluetooth Low Energy (LE) technique.

In addition, still another object of the present invention is to provide a method and apparatus for turning on or off the relay function of the nodes that establish a mesh network using a Bluetooth Low Energy (LE) technique.

In addition, still another object of the present invention is to provide a method and apparatus for determining on or off time of the relay function of the nodes that establish a mesh network using a Bluetooth Low Energy (LE) technique according to a number of retransmission of data packet.

The technical objects to attain in the present invention are not limited to the above-described technical objects and other technical objects which are not described herein will become apparent to those skilled in the art from the following description.

According to an aspect of the present invention in order to solve the problem, a method for transmitting and receiving a data packet in a Bluetooth mesh network performed by a node includes participating in the Bluetooth mesh network; receiving a first data packet from a previous node in a relay state, where the relay state is a state for relaying the data packet in a flooding technique in the mesh network; and transmitting the first data packet to at least one adjacent node, where the first data packet includes information of number of times that represents a number of retransmission of the first data packet, where the relay state is maintained for a first specific time, and wherein the first specific time is determined based on the information of number of times.

In addition, the present invention further includes receiving ACK in response to the first data packet from the at least one mode.

In addition, in the present invention, the at least one node is in a distance of 1 Hop from the node.

In addition, in the present invention, the first specific time increases as a value of the information of number of times increases, and decreases as a value of the information of number of times decreases.

In addition, in the present invention, the first data packet is repeatedly transmitted in every specific period, and the first specific time is a same as or greater than the specific period.

In addition, the present invention further includes shifting the state to a ready state that does not transmit and receive data from the relay state, where the ready state is maintained for a second specific time.

In addition, in the present invention, the second specific time decreases as a value of the information of number of times increases, and increases as a value of the information of number of times decreases.

In addition, in the present invention, the second specific time is smaller than a maximum time when the first data packet is repeatedly transmitted with a specific period.

In addition, in the present invention, the node is shifted to the ready state from the relay state after an arbitrary time, and the node is shifted to the relay state after a predetermined time.

In addition, according to another aspect of the present invention, a node for transmitting and receiving a data packet in a Bluetooth mesh network includes a communication unit for communicating to an exterior; and a processor functionally connected to the communication unit, wherein the processor is controlled to perform: participating in the Bluetooth mesh network; receiving a first data packet from a previous node in a relay state, where the relay state is a state for relaying the data packet in a flooding technique in the mesh network; and transmitting the first data packet to at least one adjacent node, where the first data packet includes information of number of times that represents a number of retransmission of the first data packet, where the relay state is maintained for a first specific time, and where the first specific time is determined based on the information of number of times.

### BRIEF DESCRIPTION OF THE DRAWINGS

FIG. 1 is a schematic view illustrating an example of a wireless communication system using a Bluetooth low energy technology to which the present invention is applicable.

FIG. 2 is an internal block diagram of an example of devices to which the present invention is applicable.

FIG. 3 is a view illustrating an example of a Bluetooth low energy topology.

FIG. 4 is a view illustrating an example of a Bluetooth communication architecture to which the present invention is applicable.

FIG. 5 is a view illustrating an example of a structure of a generic attribute profile (GATT) of Bluetooth low energy.

FIG. 6 is a schematic view illustrating an example of a Bluetooth mesh network to which the present invention is applicable.

FIG. 7 is a view illustrating an example of a protocol stack of a Bluetooth mesh network to which the present invention is applicable.

FIG. 8 is a flowchart illustrating an example of a method for a device to join a Bluetooth mesh network to which the present invention is applicable.

FIG. 9 is a view illustrating an example for a source node to transmit a message to a destination device.

FIG. 10 is a view illustrating an example of a method for turning on or off the relay function of a node in a Bluetooth mesh network to which the present invention is applicable.

FIG. 11 is a flowchart illustrating an example of a method for transmitting a data packet through a relay node in a Bluetooth mesh network to which the present invention is applicable.

FIG. 12 is a flowchart illustrating an example of a method for turning on or off the relay function of a node in a Bluetooth mesh network to which the present invention is applicable.

FIG. 13 is a flowchart illustrating an example of a method for changing a transmission period of data packet according to the number of retransmission in a Bluetooth mesh network to which the present invention is applicable.

FIG. 14 is a view illustrating an example of a method for increasing the activation time of the relay function of a node in a Bluetooth mesh network to which the present invention is applicable.

FIG. 15 is a view illustrating an example of a method for decreasing the activation time of a relay function of a node in a Bluetooth mesh network to which the present invention is applicable.

### DETAILE DESCRIPTION OF THE INVENTION

The aforementioned objects, features and advantages of the present invention will become more apparent through the following detailed description with respect to the accompanying drawings. Hereinafter, the embodiments of the present invention will be described with reference to the accompanying drawings, in which like numbers refer to like elements throughout the specification. In describing the present invention, a detailed description of known techniques associated with the present invention unnecessarily obscure the gist of the present invention, it is determined that the detailed description thereof will be omitted.

Hereinafter, a terminal related to the present invention will be described in detail with reference to the accompanying drawings. In the following description, usage of suffixes such as ‘module’, ‘part’ or ‘unit’ used for referring to elements is given merely to facilitate explanation of the present invention, without having any significant meaning by itself.

Hereinafter, the terms, “node” and “device” are given or mixed only by considering the convenience of description, and do not have distinguished meanings or roles in themselves.

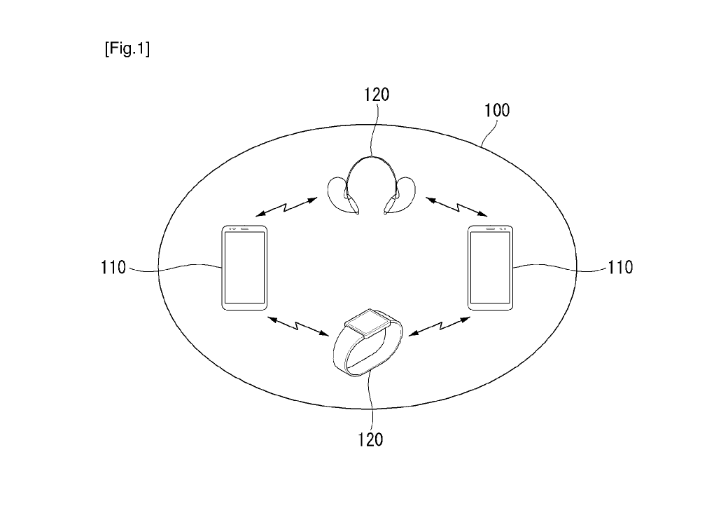

FIG. 1 is a schematic view illustrating an example of a wireless communication system using a Bluetooth low energy technology to which the present invention is applicable.

A wireless communication system 100 includes at least one server device 120 and at least one client device 110.

The server device and the client device perform Bluetooth communication using a Bluetooth low energy (BLE) technology.

First, compared with a Bluetooth basic rate/enhanced data rate (BR/EDR), the BLE technology has a relatively small duty cycle, may be produced at low cost, and significantly reduce power consumption through a low data rate, and thus, it may operate a year or longer when a coin cell battery is used.

Also, in the BLE technology, an inter-device connection procedure is simplified and a packet size is designed to be small compared with the Bluetooth BR/EDR technology.

In the BLE technology, (1) the number of RF channels is forty, (2) a data rate supports 1 Mbps, (3) topology has a scatternet structure, (4) latency is 3 ms, (5) a maximum current is 15 mA or lower, (6) output power is 10 mW (10 dBm) or less, and (7) the BLE technology is commonly used in applications such as a clock, sports, healthcare, sensors, device control, and the like.

The server device 120 may operate as a client device in a relationship with other device, and the client device may operate as a server device in a relationship with other device. That is, in the BLE communication system, any one device may operate as a server device or a client device, or may operate as both a server device and a client device if necessary.

The server device 120 may also be called as data service device, slave device, slave, server, conductor, host device, gateway, sensing device, monitoring device, first device, or the like, and the client device 110 may also be called as master device, master, client, member, sensor device, sink device, collector, second device, third device, and the like.

The server device and the client device correspond to major components of the wireless communication system, and the wireless communication system may include components other than the server device and the client device.

The server device refers to a device which receives data from the client device and provides data to the client device in response when a corresponding request is received from the client device, through direct communication with the client device.

Also, in order to provide data information to the client device, the server device sends a notification message or an indication message to the client device in order to provide data information to the client device. Also, the server device receives a confirmation message corresponding to the indication message from the client device.

Also, in the process of transmitting and receiving notification, indication, and confirmation messages to and from the client device, the server device may provide data information to a user through a display unit or may receive a request input from the user through a user input interface.

Also, in the process of transmitting and receiving message to and from the client device, the server device may read data from a memory unit or may write new data to the corresponding memory unit.

Also, the single server device may be connected with a plurality of client devices, and may be easily re-connected with client devices using bonding information.

The client device 120 refers to a device which requests data information and data transmission from the server device.

The client device receives data through a notification message or an indication message from the server device, and when an indication message is received from the server device, the client device sends an acknowledgement message in response to the indication message.

Similarly, in the process of transmitting and receiving messages to and from the server device, the client device may also provide information to the user through a display unit or may receive an input from the user through a user input interface.

Also, in the process of transmitting and receiving messages with the server device, the client device may read data from a memory unit or may write new data to the corresponding memory unit.

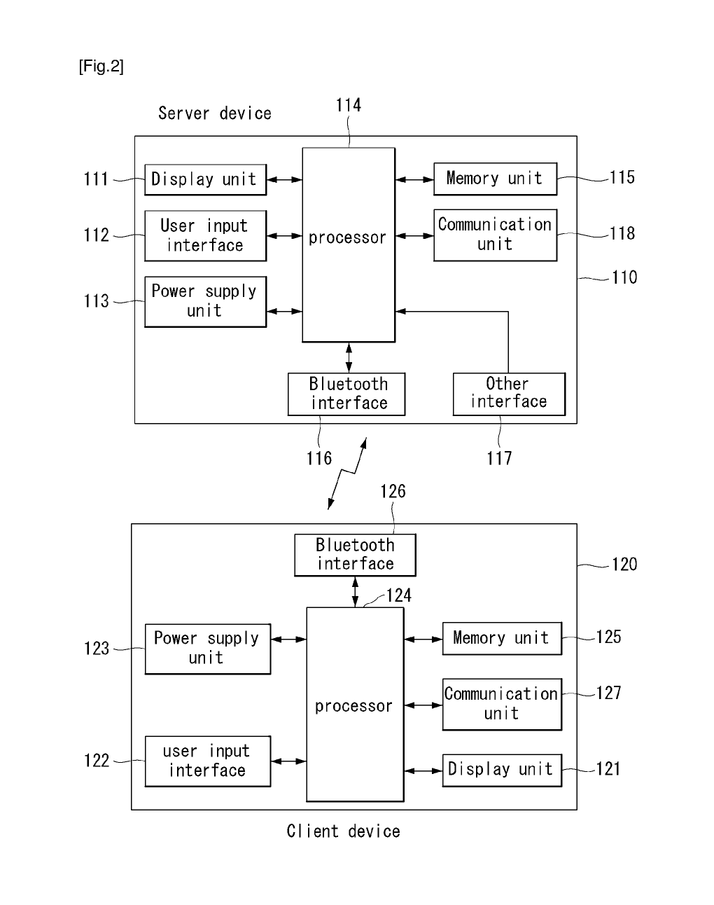

Hardware components such as the display units, the user input interfaces, and the memory units of the server device and the client device will be described in detail with reference to FIG. 2.

Also, the wireless communication system may configure personal area networking (PAN) through the Bluetooth technology. For example, in the wireless communication system, a private piconet may be established between devices to quickly and safely exchange files, documents, and the like.

FIG. 2 is an internal block diagram of an example of devices to which the present invention is applicable.

As illustrated in FIG. 2, a server device includes a display unit 111, a user input interface 112, a power supply unit 113, a processor 114, a memory unit 115, a Bluetooth interface 116, other interface 117, and a communication unit (or transceiver unit) 118.

The display unit 111, the user input interface 112, the power supply unit 113, the processor 114, the memory unit 115, the Bluetooth interface 116, other interface 117, and the communication unit 118 are functionally connected to each other to perform a method proposed in this disclosure.

Also, the client device includes a display unit 121, a user input interface 122, a power supply unit 123, a processor 124, a memory unit 125, a Bluetooth interface 126, and a communication unit (or transceiver unit) 128.

The display unit 121, the user input interface 122, the power supply unit 123, the processor 124, the memory unit 125, the Bluetooth interface 126, other interface 127, and the communication unit 128 are functionally connected to each other to perform a method proposed in this disclosure.

The Bluetooth interfaces 116 and 126 refer to units (or modules) able to transmit data such as a request/a response, a command, a notification, an indication/confirmation message between devices.

The memory units 115 and 126 are units implemented in various types of devices, in which various types of data are stored.

The processors 114 and 124 refer to modules controlling a general operation of the server device or the client device, which control requesting transmission of a message through the Bluetooth interface and other interface and processing a received message therethrough.

The processors 114 and 124 may also be termed a controller, a control unit, and the like.

The processors 114 and 124 may include an application-specific integrated circuit (ASIC), other chip set, a logic circuit and/or data processing unit.

The processors 114 and 124 control the communication units to receive an advertising message from the server device, control the communication unit to transmit a scan request message to the server device and receive a scan response message as a response to the scan request from the server device, and control the communication unit to transmit a connection request message to the server device in order to establish a Bluetooth connection with the server device.

Also, after the Bluetooth LE connection is established through the connection procedure, the processors 114 and 124 control the communication units to read or write data by using an attribute protocol from the server device

The memory units 115 and 125 may include a read-only memory (ROM), a random access memory (RAM), a flash memory, a memory card, a storage medium and/or other storage device.

The communication units 118 and 127 may include a baseband circuit for processing a wireless signal. When an embodiment is implemented by software, the aforementioned technique may be implemented as a module (process, function, etc.) performing the aforementioned function. The module may be stored in a memory unit and may be executed by a processor.

The memory units 115 may be present within or outside of the processors 114 and 124, and may be connected to the processors 114 and 124 through various well-known units.

The display units 111 and 121 refer to modules providing status information of the devices, message exchange information, and the like, to the user through a screen.

The power supply units 113 and 123 refer to modules receiving external power or internal power and supplying power required for operations of the respective components under the control of the controllers 114 and 124.

As discussed above, in the BLE technology, a duty cycle is small and power consumption may be significantly reduced through a low data rate, and thus, the power supply unit may supply power required for operations of the respective components even with small output power (10 mW (10 dBm) or less).

The user input interfaces 112 and 122 refer to modules providing a user input such as a screen button to the controllers to enable the user to control an operation of the devices.

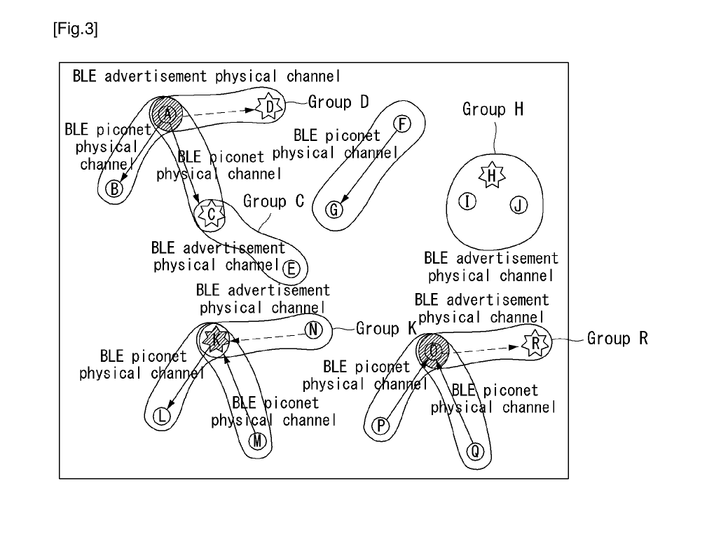

FIG. 3 is a view illustrating an example of a Bluetooth low energy topology.

Referring to FIG. 3, a device A corresponds to a master in a piconet (piconet A, the shaded portion) having a device B and a device C as slaves.

Here, the piconet refers to an aggregation of devices in which any one of them is a mater and the other devices occupy a shared physical channel connected to the master device.

The BLE slave does not share a common physical channel with the master. Each of the slaves communicates with the master trough a separate physical channel. There is another piconet (piconet F) having a master device F and a slave device G.

A device K is present in a scatternet K. Here, the scatternet refers to a group of piconets connected to other piconets.

The device K is a master of a device L and a slave of a device M.

A device O is also in the scatter net O. The device O is a slave of a device P and a slave of a device Q.

As illustrated in FIG. 2, five different device groups are present.

Device D is an advertiser and device A is an initiator (group D).

Device E is a scanner and Device C is an advertiser (group C).

Device H is an advertiser, and devices I and J are scanners (group H).

Device K is also an advertiser, and device N is an initiator (group K).

Device R is an advertiser, and device O is an initiator (group R).

The devices A and B use a single BLE piconet physical channel.

The devices A and C use another BLE piconet physical channel.

In group D, the device D advertises using an advertisement event connectable in an advertisement physical channel, and the device A is an initiator. The device A may establish a connection with the device D and add a device to the piconet A.

In group C, the device C advertises on an advertisement physical channel by using a certain type of an advertisement event captured by the scanner device E.

The group D and the group C may use different advertisement physical channels or different times in order to avoid collision.

In the piconet F, a single physical channel is present. The devices F and G use a single BLE piconet physical channel. The device F is a master, and the device G is a slave.

In group H, a single physical channel is present. The devices H, I, and J use a single BLE advertisement physical channel. The device H is an advertiser, and the devices I and J are scanners.

In the scatternet K, the devices K and L use a single BLE piconet physical channel. The devices K and M use another BLE piconet physical channel.

In group K, the device K advertises by using an advertisement event connectable on an advertisement physical channel, and the device N is an initiator. The device N may establish a connection with the device K. Here, the device K may be a slave of two devices and a master of one device at the same time.

In the scatternet O, the devices O and P use a single BLE piconet physical channel. The devices O and Q use another BLE piconet physical channel.

In group R, the device R advertises by using an advertisement event connectable on an advertisement physical channel, and the device O is an initiator. The device O may establish a connection with the device R. Here, the device O may be a slave of two devices and a master of one device at the same time.

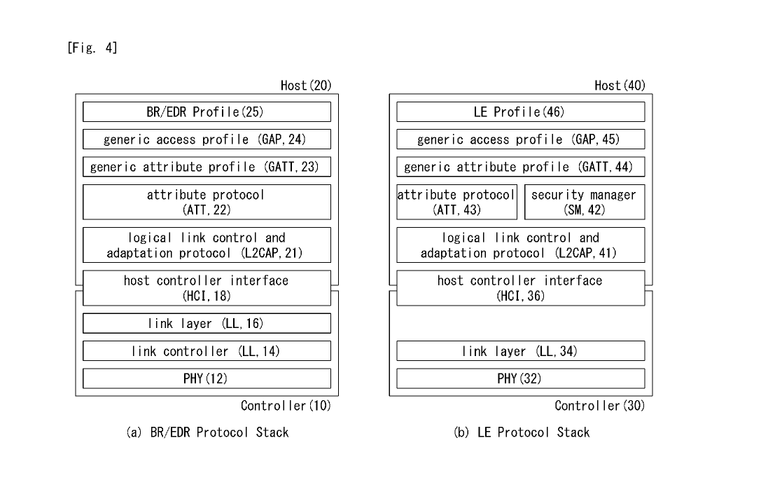

FIG. 4 is a view illustrating an example of a Bluetooth communication architecture to which the present invention is applicable.

Referring to FIG. 4, FIG. 4A shows an example of a protocol stack of Basic Rate (BR)/Enhanced Data Rate (EDR), and FIG. 4B shows an example of a protocol stack of Bluetooth Low Energy (LE).

In detail, as illustrated in (a) of FIG. 3, the Bluetooth BR/EDR protocol stack may include an upper controller stack 10 and a lower host stack 20 with respect to a host controller interface (HCI) 18.

The host stack (or host module) 20 refers to hardware for transmitting or receiving a Bluetooth packet to and from a wireless transceiver module receiving a Bluetooth signal of 2.4 GHz, and is connected to a Bluetooth module, the controller stack 10, to control the Bluetooth module and performs an operation.

The host stack 20 may include a BR/EDR PHY layer 12, a BR/EDR Baseband layer 14 and a Link Manager layer 16.

The BR/EDR PHY layer 12 is the layer of transmitting and receiving a radio signals of 2.4 GHz, and may transmit data by hopping 79 RF channels in the case of using the Gaussian Frequency Shift Keying (GFSK) modulation.

The BR/EDR Baseband layer 14 plays the role of transmitting a Digital Signal, selects the channel sequence of hopping 1400 times per second, and transmits the time slot of 625 μs length for each channel.

The Link Manager layer 16 controls the entire operations (link setup, control and security) of a Bluetooth connection by utilizing the Link Manager Protocol (LMP).

The link manager layer 16 may perform the following functions.
The link manager layer 16 may perform ACL/SCO logical transport, logical link setup, and control
Detach: The link manager layer 16 stops connection and informs a counterpart device about the reason for stopping connection.
The link manager layer 16 performs power control and role switch.
The link manager layer 16 performs security (authentication, pairing, encryption) function.

The host controller interface layer 18 provides an interface between the host module and the controller module to allow the host to provide a command and data to the controller and allow the controller to provide an event and data to the host.

The host stack (or host module) 20 includes a logical link control and adaptive protocol (L2CAP) 21, an attribute protocol (ATT) 22, a generic attribute profile (GATT) 23, a generic access profile (GAP) 24, and a BR/EDR profile 25.

The logical link control and adaptive protocol (L2CAP) 21 may provide a two-way channels for transmitting data to a specific protocol or a profile.

The L2CAP 21 may multiplex various protocols and profiles provided from a Bluetooth higher position.

The L2CAP of the Bluetooth BR/EDR uses a dynamic channel, supports a protocol service multiplexer, retransmission, and a streaming mode, and provides segmentation and reassembly, per-channel flow control, and error control.

The generic attribute profile (GATT) 23 may operate as a protocol how the attribute protocol 22 is used in configuring services. For example, the generic attribute profile 23 may operate how ATT attributes are grouped together with services, and operate to describe features associated with services.

Thus, the GATT 23 and the ATT 22 may use features in order to describe status and services of a device and describe how the features are related and used.

The attribute protocol 22 and the BR/EDR profile 25 define a service (profile) using the Bluetooth BR/EDR and define an application protocol for exchanging data, and the generic access profile (GAP) 24 defines device discovering, connecting a device and security level.

As illustrated in (b) of FIG. 4, the Bluetooth LE protocol stack includes a controller stack 30 operable to process a wireless device interface for which timing is important, and a host stack 40 operable to process high level data.

First, the controller stack 30 may be implemented by using a communication module that may include a Bluetooth wireless device, for example, a processor module that may include a processing device such as a microprocessor.

The host stack may be implemented as part of an OS operated on a processor module or may be implemented as instantiation of a package on the OS.

In some examples, the controller stack and the host stack may be operated or executed on the same processing device within a processor module.

The controller stack 30 includes a physical layer (PHY) 32, a link layer (LL) 34, and a host controller interface (HCI) 36.

The physical layer (PHY) (wireless transceiver module 32), a layer for transmitting and receiving a 2.4 GHz wireless signal, uses a Gaussian frequency shift keying (GFSK) modulation and a frequency hopping technique including forty RF channels.

The link layer 34 serving to transmit or receive a Bluetooth packet provides a function of generating a connection between devices after performing an advertising and scanning function using three advertising channels, and exchanging data packets of a maximum of 257 bytes through thirty-seven data channels.

The host stack may include the Generic Access Profile (GAP) 40, the logical link control and adaptation protocol (L2CAP) 41, the Security Manager (SM) 42, the Attribute Protocol (ATT) 440, the Generic Attribute Profile (GATT) 44, the Generic Access Profile 25 and the LE profile 46. However, the host stack 40 is not limited thereto, but may include other various protocols and profiles.

The host stack multiplexes various protocols and profiles provided from a Bluetooth higher position by using the L2CAP.

First, the L2CAP 41 may provide a single two-way channel for transmitting data to a specific protocol or profile.

The L2CAP 41 may operate to multiplex data between higher layer protocols, segment and reassemble packages, and manage a multicast data transmission.

In the Bluetooth LE, three fixed channels (one for a signaling channel, one for a security manager, and one for an attribute protocol) are basically used, and dynamic channel may be used as necessary.

In contrast, in the BR/EDR, a dynamic channel is basically used, and a protocol service multiplexer, retransmission, streaming mode, and the like, are supported.

The SM 42 is a protocol for certifying a device and providing a key distribution.

The ATT 43 defines a rule for accessing data of a counterpart device by a server-client structure. The ATT 43 includes six types of messages (request, response, command, notification, indication, and confirmation) as follows.

\textcircled{1} Request and Response message: A request message is a message for a client device to request specific information from a server device, and the response message, as a response message with respect to the request message, refers to a message transmitted from the server device to the client device.

\textcircled{2} Command message: It is a message transmitted from the client device to the server device in order to indicate a command of a specific operation. The server device does not transmit a response with respect to the command message to the client device.

\textcircled{3} Notification message: It is a message transmitted from the server device to the client device in order to notify an event, or the like. The client device does not transmit a confirmation message with respect to the notification message to the server device.

\textcircled{4} Indication and confirmation message: It is a message transmitted from the server device to the client device in order to notify an event, or the like. Unlike the notification message, the client device transmits a confirmation message regarding the indication message to the server device.

In the present invention, when the GATT profile using the attribute protocol (ATT) 43 requests long data, a value regarding a data length is transmitted to allow a client to clearly know the data length, and a characteristic value may be received from a server by using a universal unique identifier (UUID).

The generic access profile (GAP) 45, a layer newly implemented for the Bluetooth LE technology, is used to select a role for communication between Bluetooth LED devices and to control how a multi-profile operation takes place.

Also, the generic access profile (GAP) 45 is mainly used for device discovery, connection generation, and security procedure part, defines a scheme for providing information to a user, and defines types of attributes as follows.

\textcircled{1} Service: It defines a basic operation of a device by a combination of behaviors related to data

\textcircled{2} Include: It defines a relationship between services

\textcircled{3} Characteristics: It is a data value used in a server

\textcircled{4} Behavior: It is a format that may be read by a computer defined by a UUID (value type).

The LE profile 46, including profiles dependent upon the GATT, is mainly applied to a Bluetooth LE device. The LE profile 46 may include, for example, Battery, Time, FindMe, Proximity, Time, Object Delivery Service, and the like, and details of the GATT-based profiles are as follows.

\textcircled{1} Battery: Battery information exchanging method

\textcircled{2} Time: Time information exchanging method

\textcircled{3} FindMe: Provision of alarm service according to distance

\textcircled{4} Proximity: Battery information exchanging method

\textcircled{5} Time: Time information exchanging method

The generic attribute profile (GATT) 44 may operate as a protocol describing how the attribute protocol (ATT) 43 is used when services are configured. For example, the GATT 44 may operate to define how ATT attributes are grouped together with services and operate to describe features associated with services.

Thus, the GATT 44 and the ATT 43 may use features in order to describe status and services of a device and describe how the features are related and used.

Hereinafter, procedures of the Bluetooth low energy (BLE) technology will be briefly described.

The BLE procedure may be classified as a device filtering procedure, an advertising procedure, a scanning procedure, a discovering procedure, and a connecting procedure.

Device Filtering Procedure

The device filtering procedure is a method for reducing the number of devices performing a response with respect to a request, indication, notification, and the like, in the controller stack.

When requests are received from all the devices, it is not necessary to respond thereto, and thus, the controller stack may perform control to reduce the number of transmitted requests to reduce power consumption.

An advertising device or scanning device may perform the device filtering procedure to limit devices for receiving an advertising packet, a scan request or a connection request.

Here, the advertising device refers to a device transmitting an advertisement event, that is, a device performing an advertisement and is also termed an advertiser.

The scanning device refers to a device performing scanning, that is, a device transmitting a scan request.

In the BLE, in a case in which the scanning device receives some advertising packets from the advertising device, the scanning device should transmit a scan request to the advertising device.

However, in a case in which a device filtering procedure is used so a scan request transmission is not required, the scanning device may disregard the advertising packets transmitted from the advertising device.

Even in a connection request process, the device filtering procedure may be used. In a case in which device filtering is used in the connection request process, it is not necessary to transmit a response with respect to the connection request by disregarding the connection request.

Advertising Procedure

The advertising device performs an advertizing procedure to perform undirected broadcast to devices within a region.

Here, the undirected broadcast is advertizing toward all the devices, rather than broadcast toward a specific device, and all the devices may scan advertising to make an additional information request or a connection request.

In contrast, directed advertising may make an additional information request or a connection request by scanning advertising for only a device designated as a reception device.

The advertising procedure is used to establish a Bluetooth connection with an initiating device nearby.

Or, the advertising procedure may be used to provide periodical broadcast of user data to scanning devices performing listening in an advertising channel.

In the advertising procedure, all the advertisements (or advertisement events) are broadcast through an advertisement physical channel.

The advertising devices may receive scan requests from listening devices performing listening to obtain additional user data from advertising devices. The advertising devices transmit responses with respect to the scan requests to the devices which have transmitted the scan requests, through the same advertising physical channels as the advertising physical channels in which the scan requests have been received.

Broadcast user data sent as part of advertising packets are dynamic data, while the scan response data is generally static data.

The advertisement device may receive a connection request from an initiating device on an advertising (broadcast) physical channel. If the advertising device has used a connectable advertising event and the initiating device has not been filtered according to the device filtering procedure, the advertising device may stop advertising and enter a connected mode. The advertising device may start advertising after the connected mode.

Scanning Procedure

A device performing scanning, that is, a scanning device performs a scanning procedure to listen to undirected broadcasting of user data from advertising devices using an advertising physical channel.

The scanning device transmits a scan request to an advertising device through an advertising physical channel in order to request additional data from the advertising device. The advertising device transmits a scan response as a response with respect to the scan request, by including additional user data which has requested by the scanning device through an advertising physical channel.

The scanning procedure may be used while being connected to other BLE device in the BLE piconet.

If the scanning device is in an initiator mode in which the scanning device may receive an advertising event and initiates a connection request. The scanning device may transmit a connection request to the advertising device through the advertising physical channel to start a Bluetooth connection with the advertising device.

When the scanning device transmits a connection request to the advertising device, the scanning device stops the initiator mode scanning for additional broadcast and enters the connected mode.

Discovering Procedure

Devices available for Bluetooth communication (hereinafter, referred to as “Bluetooth devices”) perform an advertising procedure and a scanning procedure in order to discover devices located nearby or in order to be discovered by other devices within a given area.

The discovering procedure is performed asymmetrically. A Bluetooth device intending to discover other device nearby is termed a discovering device, and listens to discover devices advertising an advertising event that may be scanned. A Bluetooth device which may be discovered by other device and available to be used is termed a discoverable device and positively broadcasts an advertising event such that it may be scanned by other device through an advertising (broadcast) physical channel.

Both the discovering device and the discoverable device may have already been connected with other Bluetooth devices in a piconet.

Connecting Procedure

A connecting procedure is asymmetrical, and requests that, while a specific Bluetooth device is performing an advertising procedure, another Bluetooth device should perform a scanning procedure.

That is, an advertising procedure may be aimed, and as a result, only one device may response to the advertising. After a connectable advertising event is received from an advertising device, a connecting request may be transmitted to the advertising device through an advertising (broadcast) physical channel to initiate connection.

Hereinafter, operational states, that is, an advertising state, a scanning state, an initiating state, and a connection state, in the BLE technology will be briefly described.

Advertising State

A link layer (LL) enters an advertising state according to an instruction from a host (stack). In a case in which the LL is in the advertising state, the LL transmits an advertising packet data unit (PDU) in advertising events.

Each of the advertising events include at least one advertising PDU, and the advertising PDU is transmitted through an advertising channel index in use. After the advertising PDU is transmitted through an advertising channel index in use, the advertising event may be terminated, or in a case in which the advertising device may need to secure a space for performing other function, the advertising event may be terminated earlier.

Scanning State

The LL enters the scanning state according to an instruction from the host (stack). In the scanning state, the LL listens to advertising channel indices.

The scanning state includes two types: passive scanning and active scanning. Each of the scanning types is determined by the host.

Time for performing scanning or an advertising channel index are not defined.

During the scanning state, the LL listens to an advertising channel index in a scan window duration. A scan interval is defined as an interval between start points of two continuous scan windows.

When there is no collision in scheduling, the LL should listen in order to complete all the scan intervals of the scan window as instructed by the host. In each scan window, the LL should scan other advertising channel index. The LL uses every available advertising channel index.

In the passive scanning, the LL only receives packets and cannot transmit any packet.

In the active scanning, the LL performs listening in order to be relied on an advertising PDU type for requesting advertising PDUs and advertising device-related additional information from the advertising device.

Initiating State

The LL enters the initiating state according to an instruction from the host (stack).

When the LL is in the initiating state, the LL performs listening on advertising channel indices.

During the initiating state, the LL listens to an advertising channel index during the scan window interval.

Connection State

When the device performing a connection state, that is, when the initiating device transmits a CONNECT_REQ PDU to the advertising device or when the advertising device receives a CONNECT_REQ PDU from the initiating device, the LL enters a connection state.

It is considered that a connection is generated after the LL enters the connection state. However, it is not necessary to consider that the connection should be established at a point in time at which the LL enters the connection state. The only difference between a newly generated connection and an already established connection is a LL connection supervision timeout value.

When two devices are connected, the two devices play different roles.

An LL serving as a master is termed a master, and an LL serving as a slave is termed a slave. The master adjusts a timing of a connecting event, and the connecting event refers to a point in time at which the master and the slave are synchronized.

Hereinafter, packets defined in an Bluetooth interface will be briefly described. BLE devices use packets defined as follows.

Packet Format

The LL has only one packet format used for both an advertising channel packet and a data channel packet.

Each packet includes four fields of a preamble, an access address, a PDU, and a CRC.

When one packet is transmitted in an advertising physical channel, the PDU may be an advertising channel PDU, and when one packet is transmitted in a data physical channel, the PDU may be a data channel PDU.

Advertising Channel PDU

An advertising channel PDU has a 16-bit header and payload having various sizes.

A PDU type field of the advertising channel PDU included in the heater indicates PDU types defined in Table 1 below.

TABLE 1

| PDU Type | Packet Name |
|---|---|
| 0000 | ADV_IND |
| 0001 | ADV_DIRECT_IND |
| 0010 | ADV_NONCONN_IND |
| 0011 | SCAN_REQ |
| 0100 | SCAN_RSP |
| 0101 | CONNECT_REQ |
| 0110 | ADV_SCAN_IND |
| 0111-1111 | Reserved |

Advertising PDU

The following advertising channel PDU types are termed advertising PDUs and used in a specific event.

ADV_IND: Connectable undirected advertising event

ADV_DIRECT_IND: Connectable directed advertising event

ADV_NONCONN_IND: Unconnectable undirected advertising event

ADV_SCAN_IND: Scannable undirected advertising event

The PDUs are transmitted from the LL in an advertising state, and received by the LL in a scanning state or in an initiating state.

Scanning PDU

The following advertising channel DPU types are termed scanning PDUs and are used in a state described hereinafter.

SCAN_REQ: Transmitted by the LL in a scanning state and received by the LL in an advertising state.

SCAN_RSP: Transmitted by the LL in the advertising state and received by the LL in the scanning state.

Initiating PDU

The following advertising channel PDU type is termed an initiating PDU.

CONNECT_REQ: Transmitted by the LL in the initiating state and received by the LL in the advertising state.

Data Channel PDU

The data channel PDU may include a message integrity check (MIC) field having a 16-bit header and payload having various sizes.

The procedures, states, and packet formats in the BLE technology discussed above may be applied to perform the methods proposed in this disclosure.

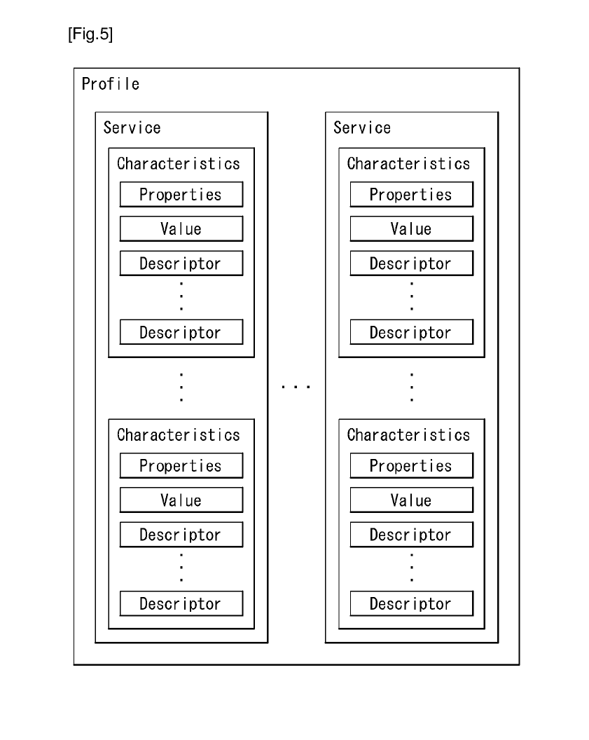

FIG. 5 is a view illustrating an example of a structure of a generic attribute profile (GATT) of Bluetooth low energy.

Referring to FIG. 5, the structure for exchange of Profile Data of Bluetooth Low Energy will be described.

In detail, the GATT defines a method for exchanging data using a service between Bluetooth LE devices and a characteristic.

In general, a peripheral device (for example, a sensor device) serves as a GATT server, and has definition regarding a service and a characteristic.

In order to read or write data, a GATT client sends a data request to the GATT server, and every operation (transaction) is started by the GATT client and a response is received from the GATT server.

A GATT-based operational structure used in the Bluetooth LE may be a vertical structure as illustrated in FIG. 5 on the basis of a profile, a service, and a characteristic.

The profile includes one or more services, and the services may include one or more characteristics or other services.

The service serves to divide data into logical units and may include one or more characteristics or other services, each of the services has a 16-bit or 128-bit identifier called a universal unique identifier (UUID)).

The characteristic is the lowermost unit in the GATT-based operational structure. The characteristic includes only one data, and has a 16-bit or 128-bit UUID, similar to the service.

The characteristic is defined by values of various types of information, and in order to hold each information, an attribute may be required for each information. The characteristic may use several continuous attributes.

The attribute has four components and has meanings as follows.
handle: Address of attribute
Type: Type of attribute
Value: Value of attribute
Permission: Right to access attribute

However, in the Bluetooth LE, the restriction in a transmission distance may occur according to the strength of radio wave. That is, since a signal and data are exchanged between devices through a connection, the data is able to be exchanged within the range in which the radio wave may be reached.

Accordingly, when the distance between devices is not reachable by the radio wave, the connection is not available, and accordingly, it is unable to communicate with each other.

As a method for solving the problem, the mesh network may be formed with the devices in which the Bluetooth is installed.

Hereinafter, the mesh network will be described.

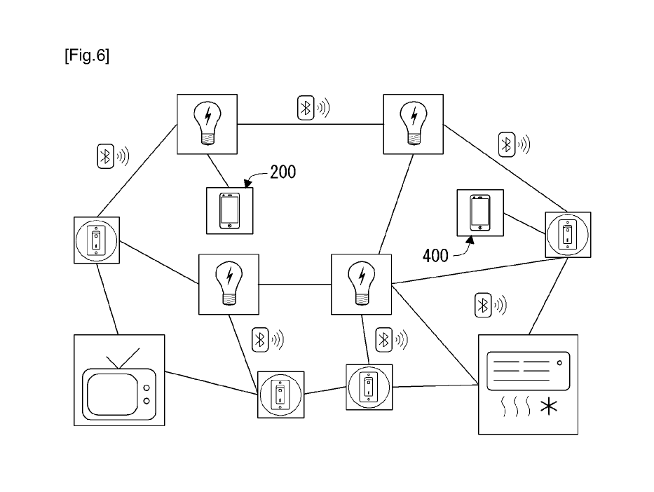

FIG. 6 is a schematic view illustrating an example of a Bluetooth mesh network to which the present invention is applicable.

As illustrated in FIG. 6, a mesh network refers to a network in which multiple devices are connected to each other and can send and receive data over Bluetooth.

A Bluetooth mesh network is made up of relay nodes that relay messages between a source device 200 that sends data and a destination device 400 that receives data.

Alternatively, the Bluetooth mesh network may include edge nodes 200 and 400 and relay nodes.

As used herein, the term “node” refers to devices that form a mesh network, and the terms “node” and “device” can be used together.

Each node has a message cache of recently received messages. If a received message is already in the message cache, this message is not relayed any longer.

However, if the received message is not in the message cache, the message is relayed and stored in the message cache.

An edge node usually get its power from a battery, and is in sleep state at normal times and may wake up for interaction or periodically.

The edge node may handle a received message if the following conditions are met:

The message is not in the message cache.

The message is authenticated by a known network key.

The destination of the message is the edge node's unicast address, a broadcast address or group address to which the edge node belongs.

A relay node is usually a device that draws main power, which is always awake and transmits received data for other nodes.

The relay node may retransmit a received message to other nodes if the following conditions are met:

The message is not in the message cache.

The message is authenticated by a known network key.

The field (e.g., relay value) indicating whether to relay the message has a value that permits relaying.

The destination address is not a unicast address assigned for the relay node.

Bluetooth mesh networks may use either a flooding technique or a routing technique, depending on how relay nodes transmit data.

In the routing technique, the source device 200 sends a message to a particular relay node, and the particular relay node, upon receiving the message, transmits the message based on information on another relay node or the destination device 400 to which the message is to be retransmitted.

The routing technique uses a broadcasting channel or point-to-point connection so as to receive and retransmit messages.

A routing device that receives a message using the routing technique determines the best routing route(s) along which the message is to be sent to an intermediate device or destination device, and decides which route to take to send the message based on a determined routing table.

With routing, however, messages need to maintain their routing tables when they are sent. Thus, the routing technique becomes more complex and requires more memory as the number of messages increase. Also, the routing technique is less dynamic and more difficult to implement than the flooding technique, but offers good extensibility.

The flooding technique refers to a technique in which relay nodes receive a message and transmit it over the air via radio waves having the characteristic of propagating into the air in all directions.

That is, the source device 200 sends a message to relay nodes via broadcast channels, and the relay nodes receive and forward the message to neighboring relay nodes so that it is delivered to the destination device 400.

The flooding technique uses a broadcast channel to receive and retransmit messages, thus extending the transmission range of messages.

A mesh network using the flooding technique is a dynamic network. In the mesh network using the flooding technique, a device can receive and transmit (or retransmit) a message at any time as long as its density allows it.

The flooding technique is easy to implement, but may have extensibility issues arising from an extended network because messages are sent directionlessly.

That is, in the mesh network using the flooding technique, when a device sends a message, multiple devices receive the message and forward the received message to other devices.

Unlike the routing technique, the flooding technique enables the transfer of a message easily without the cost of constructing a routing table, but increases network traffic because all relay devices that receive the message retransmit it.

To avoid this, the number of devices on the mesh network may be adjusted between 100 and 1,000, and the exact number of devices may be determined by a number of factors.

For example, the exact number of devices may be determined by network capacity, traffic load of data sources, network latency, reliability requirements, etc.

As such, each of the routing technique and the flooding technique has the disadvantage as well as the advantage.

In addition, as for a node that receives a message and transmits it to the next node, there is a problem that the node is unable to know in which way between the routing technique and the flooding technique the received message is to be transmitted.

Accordingly, the present invention proposes a method for a node that forms a Bluetooth mesh network to determine in which way the message transmitted from the previous node is transmitted between the routing technique or the flooding technique, and to transmit the received message in either way of the routing technique or the flooding technique to the next node.

In the present disclosure, the Hop represents the link between devices in the Bluetooth mesh network. That is, the link formed between a source device and a relay device, between relay devices, between a relay device and a destination device and between a source device and a destination device may be referred to as a Hop.

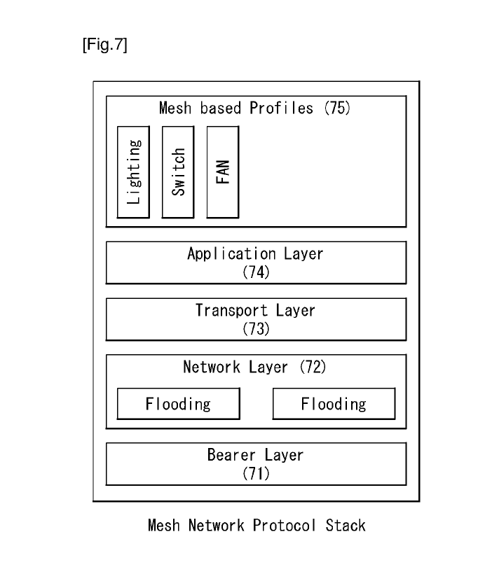

FIG. 7 is a view illustrating an example of a protocol stack of a Bluetooth mesh network to which the present invention is applicable.

Referring to FIG. 7, a protocol stack of the mesh network includes a bearer layer 71, a network layer 72, a transport layer 73, an application layer 74 and a mesh based profile.

The bearer layer 71 defines a method for a message to be transmitted between nodes in the Bluetooth mesh network. That is, in the mesh network, the bearer where a message is transmitted is determined.

An advertising bearer and a GATT bearer are existed in the mesh network for transmitting a message.

The network layer 72 is a layer for forwarding a message through an address of a source node for transmitting a message or an address of a destination node to which a message is to be forwarded, and defines a method for a node to receive a message and to retransmit it to neighboring nodes again and the formats of messages.

The message transmission method defined in the network layer 72 may include the flooding technique, the routing technique, and so on as described above.

In addition, the network layer 72 defines whether a message is relayed or forwarded and a method for authenticating and encoding network messages.

The transport layer 73 is a layer for defining the encryption and authentication of the application data by providing the confidentiality of an application message, and encodes the data transmitted from the application layer 74 with an application key and forwards it the network layer 72.

The application layer 74 defines a packet format of a message so as to use a defined operation code (Opcode) and parameters.

The mesh based profile 75 defines the profiles that may be provided in the Bluetooth mesh network.

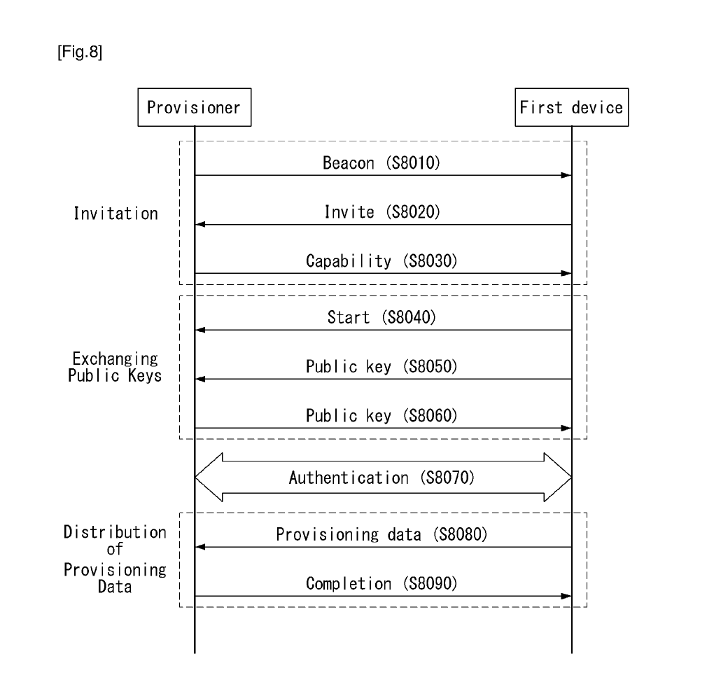

FIG. 8 is a flowchart illustrating an example of a method for a device to join a Bluetooth mesh network to which the present invention is applicable.

A new device or a device which is not provisioned should go through a provisioning procedure in order to operate by being joined in a mesh network.

The provisioning procedure means a procedure of authenticating the device which is not authenticated, and providing the basic information (e.g., Unicast Address, all types of keys, etc.) for participating in the mesh network.

That is, the provisioning procedure is a procedure for a Provisioner in the mesh network to provide the information for participating in the mesh network, and the first device may acquire the address of network, keys and various types of information for operating as a part of device indicators and the mesh network.

The provisioning procedure includes Invitation Step, Exchanging Public Key Step, Authentication Step and Distribution of Provisioning Step.

The provisioning procedure may be performed through various types of bearers. For example, the provisioning procedure may be performed by an advertising-based bearer, a Mesh Provisioning Service-based bearer or a Mesh-based bearer.

The advertising-based bearer is a bear which is essentially established, and in the case that the advertising-based bearer is not supported or the provisioning data is unable to be transmitted through the advertising-based bearer, the Provisioning Service-based bearer or the Mesh-based bearer may be used for the provisioning procedure.

The Provisioning Service-based bearer means a bearer for exchanging the provisioning data through the GATT protocol of the existing Bluetooth LE, and the Mesh-based bearer means a bearer for exchanging the provisioning data through the mesh network in the case that the first device and the second device are existed in the distance for directly exchanging data.

Subsequently, the establishing procedure for the advertising-based bearer will be described.

After the bearer is established between the first device and the second device, the first device may be provisioned through the provisioning procedure below.

Invitation Step

The invitation step is started while the second device scans the first device. The first device transmits a beacon message to the second device (step, S8010). The beacon message includes a UUID of the first device.

The second device that scans the first device 300 through the beacon message transmits an Invitation message to the first device (step, S8020).

The invitation message is a message for asking whether the first device performs the provisioning procedure. In the case that the first device does not want to perform the provisioning procedure, the first device ignores the invitation message.

However, in the case that the first device wants to perform the provisioning procedure, that is, to participate in the mesh network, the first device transmits a capability message in response to it (step, S8030).

The capability message may include the information that represents whether the first device supports a security algorithm configuration, a Public Key, the information on whether to output a value to a user, the information on whether to receive an input value from a user, and so on.

Exchanging Public Key Step

Later, the second device transmits a start message for starting the provisioning to the first device (step, S8040).

In the case of being unable to use the Public Key using an out of band technology, the first device and the second device exchange the Public Keys (steps, S8050 and S8060).

However, in the case of being able to use the Public Key using the out of band technology, the second device transmits an ephemeral public key to the first device, and read a static public key using the out of band technology from the first device.

Later, the second device authenticates the first device by performing the authentication procedure with the first device (step, S8070).

Distribution of Provisioning Data Step

When the first device is authenticated, the second device and the first device calculate and generate a session key.

Later, the second device transmits the provisioning data to the first device (step, S8080).

The provisioning data may include an application key, a device key, a network key, an IV index, a Unicast address, and so on.

The first device that receives the provisioning data transmits a completion message in response to it, and the provisioning procedure is ended (step, S8090).

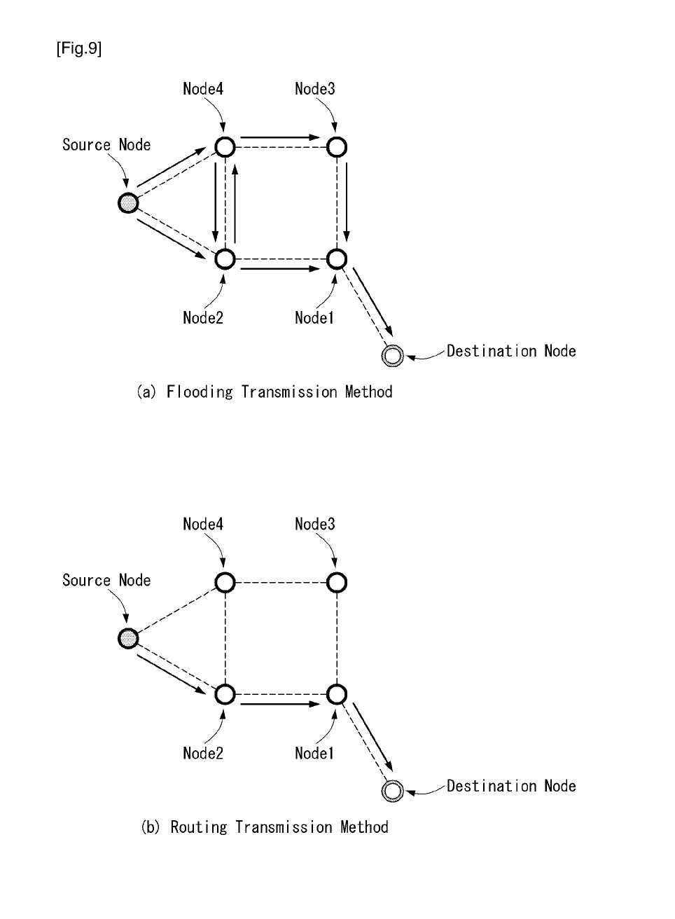

FIG. 9 is a view illustrating an example for a source node to transmit a message to a destination device.

Referring to FIG. 9, in a Bluetooth mesh network, a source node (SRC) may transmit a message to a destination node (DST) through (a) the flooding technique or (b) the routing technique.

Particularly, the flooding technique means a technique of transmitting a message to all of the adjacent neighbor nodes. That is, as shown in FIG. 9A, the source node transmits a message to the nodes (node 2 and node 4) which are adjacent to its own, and the node 2 and the node 4 transmit the message to neighbor nodes again by identifying the received message if the message is not transmitted to them.

For example, the node 4 identifies the received message, and in the case that the destination address included in the message is not its own address, the node 4 relays the message to neighbor nodes.

In this case, the node 4 may not transmit the message to the node that transmits the message to its own node. For example, in FIG. 9A, the node 3 may not relay the message to the node 4 that transmits the message to the node 3 itself.

Through the method as such, the source node may transmit a message to the destination node.

Different from the flooding technique, the routing technique means a technique of transmitting a message according to a specific path. That is, as shown in FIG. 9B, the source node may transmit a message to the destination node through specific nodes according to a specific path (hereinafter, referred to as a routing path).

For example, in order to transmit a message, the source node may transmit a message to the node 2, and the node 2 may transmit the message to the destination node by retransmitting the message to the node 1.

In this case, the routing path may be determined based on the source node or based on the destination address that represents the destination node included in the message.

In the case that the routing path is determined based on the source node, the source node may transmit the information of the routing path with being included in the message, and the nodes that receive the message may transmit the message to the next node according to the information of the routing path.

However, in the case that the routing path is determined according to the destination address, the source node transmits the message that does not include the information of entire paths to the node 2. The node 2 that receives it may determine the next node to which the message is going to be transmitted based on the destination address, and transmit the message to the determined node.

The role of transmitting the received message to the next node according to the routing path in the routing technique may be referred to as a routing role and the node that performs the routing role may be called a router.

The nodes in such a Bluetooth mesh network may transmit a message through a technique between the flooding technique and the routing technique.

However, although the flooding transmission technique shown in FIG. 9A has an advantage of having a simple system and a control structure, since the data packet (or message) that all intermediate nodes between a source node and a destination node receive are transmitted to adjacent other nodes, there is an advantage that the traffic increases owing to it.

Accordingly, in order to solve the problem, the present invention provides a method of activating and deactivating the relay function that forwards the data packet that the nodes receive in a Bluetooth mesh network to an adjacent node.

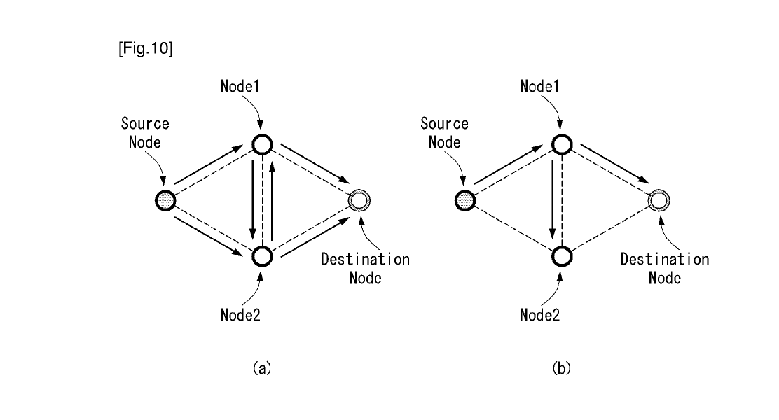

FIG. 10 is a view illustrating an example of a method for turning on or off the relay function of a node in a Bluetooth mesh network to which the present invention is applicable.

Referring to FIG. 10, in the case of transmitting a data packet through the flooding transmission technique, by deactivating the relay function of a part of nodes among the nodes existed between a source node and a destination node, the data packet may be prevented from being relayed unnecessarily.

Particularly, in the case that the source node transmits the data packet to the destination node through the conventional flooding transmission technique, as shown in FIG. 10A, all nodes existed between the source node and the destination node relay the received data packet to adjacent nodes.

That is, in the case that both of the source node and the destination node are existed within the transmission range of node 1 and node 2, the data packet transmission toward the destination node repeatedly occurs through the node 1 and the node 2.

As such, when the nodes that play the role of relay repeatedly relay the data packet, the transmission use efficiency of the relay nodes decreases. In addition, the power consumption increases since the destination node also receives the repeated data packet.

Accordingly, in order to solve it, the relay function of a part of nodes that play the role of relay existed between the source node and the destination node may be deactivated.

That is, as shown in FIG. 10B, by deactivating (or turning off) the relay function of the node 2, it may be implemented that only the node 1 may relay the data packet transmitted from the source device.

In particular, in the case that the node 1 and the node 2 that establish a mesh network perform the role of relay nodes that have the function of relaying the received data packet to adjacent nodes (e.g., the node existed in a distance of 1 Hop), the relay function of data packet of one node between the node 1 and the node 2 may be deactivated or activated.

In this case, the node in which the function of retransmitting the received packet to an adjacent node is activated with performing the role of relay may be called the relay node.

Otherwise, the state of node in which the relay function is activated may be called the relay state.

In addition, the node in which the function of retransmitting the received data packet to an adjacent node is deactivated with performing the role of relay may be called the relay ready node.

Otherwise, the state of node in which the relay function is deactivated may be called the ready state.

In FIG. 10B, the relay function of data packet is activated in the node 1 and the relay function of data packet is deactivated in the node 2.

Accordingly, in the case that the source device transmits a data packet to adjacent nodes, the node 1 may relay the data packet to an adjacent node by receiving the data packet, but the node 2 is unable to relay the data packet since the retransmission function of the data packet is deactivated.

In the case that a Bluetooth mesh network is initially generated, the packet relay function of the nodes that play the role of relay is activated. Later, after an arbitrary time is elapsed, the relay function of the data packet of the nodes that play the role of relay may be deactivated.

That is, the relay function of data packet of the nodes that play the role of relay in a mesh network is deactivated after the respective time is elapsed.

In the case that a specific node joins in a mesh network, the relay function of data packet of the specific node may be deactivated after an arbitrary time is elapsed.

For example, in FIG. 10B, after a mesh network is formed, the relay function of packet of the node 2 may be deactivated after a predetermined time. In addition, after a mesh network is formed, the relay function of packet of the node 1 may also be deactivated after a predetermined time. In this case, since the relay function of data packet of the node 1 and the node 2 is deactivated after an arbitrary time, the time when the relay function of data packet is deactivated may be either identical or not identical.

In the case of transmitting data packet using the flooding transmission technique through such a method, the data packet may be efficiently transmitted by deactivating the relay function of data packet of the node that performs the role of relay.

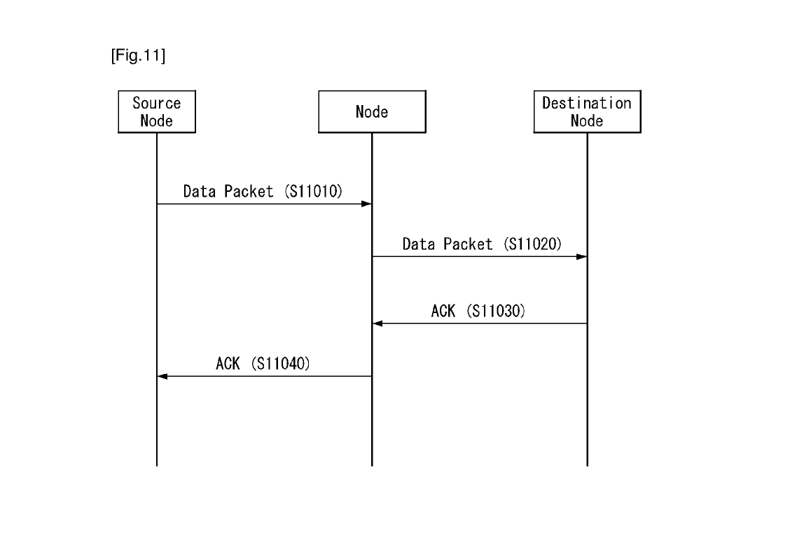

FIG. 11 is a flowchart illustrating an example of a method for transmitting a data packet through a relay node in a Bluetooth mesh network to which the present invention is applicable.

Referring to FIG. 11, in the case that a destination node that is a destination to which a data packet is transmitted in a Bluetooth mesh network receives the data packet, the destination node may transmit an acknowledgement (hereinafter, ACK) in response to it.

Particularly, a source node transmits a data packet to an adjacent node using the flooding technique (step, S11010).

In this case, the destination of the data packet may be established to the address of the destination node.

The relay nodes that play the role of relay among the adjacent nodes that receive the data packet relay the received data packet to an adjacent node (step, S11020).

In this case, the relay function of data packet of the relay node is activated (or turned on), and the adjacent node may be another relay node or the destination node.

In the case that the adjacent node that receives the data node is the destination node, the destination node transmits ACK to the adjacent node in response to it (step, S11030).

The relay nodes that perform the role of relay among the adjacent nodes that receive the data packet relay the received ACK to an adjacent node (step, S11040).

In this case, the adjacent node may be another relay node or the source node.

The source node that receives the ACK may know that the data packet transmitted by the source node itself is transmitted to a destination device, and does not transmit the data packet again since the data packet is normally transmitted.

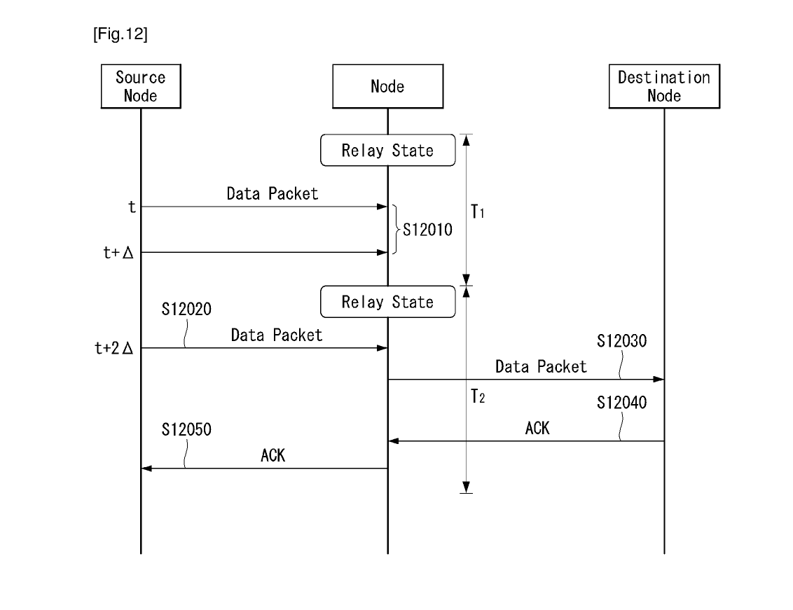

FIG. 12 is a flowchart illustrating an example of a method for turning on or off the relay function of a node in a Bluetooth mesh network to which the present invention is applicable.

Referring to FIG. 12, the relay node that plays the role of relay in a Bluetooth mesh network may determine an activation or deactivation time of the relay function according to the number of times of the received data packet that is retransmitted from a source node or a previous relay node.

In particular, the source node transmits the data packet to an adjacent node using the flooding technique on time t. In this case, the destination of the data packet is established to the address of the destination node.

However, in the case that the node is existed in a relay ready node or in a ready state since the relay function of the node that receives the data packet is deactivated, the node does not relay the received data packet.

In this case, the relay function of the node is deactivated during T₁ which is a specific time (a first specific time), the T₁ may have a value of natural number of 1 or higher.

In the case that the node is unable to receive ACK with respect to the data packet during a predetermined time after transmitting the data packet, the node retransmits the data packet on every specific period.

For example, in the case that the source node is unable to receive ACK after the source node transmits the data packet on the time t, the source node retransmits the data packet after A time (step, S12010).

In this case, the data packet may include the information of the number of times that represent the data packet retransmitted, and the information may be represented as 1 time retransmission since the data packet is retransmitted once.

However, since the relay function of the node is deactivated during the time T₁, the source node does not retransmit the data packet that the source node retransmits.

Later, after the time T₁ is elapse, the relay function of the node is activated. That is, the node may play the role of relay during playing the role of relay ready.

Otherwise, the state may be shifted from the ready state to the relay state.

The relay function is activated during a specific time (a second specific time) T₂, the T₂ may have a value of natural number of 1 or higher.

Since the source node is unable to receive ACK since the data packet retransmitted once is not transmitted to a destination node, the source node may retransmit the data packet after A time again (step, S12020).

In this case, the retransmitted packet may be represented as the retransmission of twice since it is retransmitted 2 times.

The node that receives the data packet retransmitted twice relays the data packet to the destination node since the relay function of the node is activated (step, S12030).

The node may know that there exists a data packet that the node fails to receive through the information of the number of times included in the data packet.

That is, the node may know the retransmitted number of the data packet through the information of the number of times, and may change the value of T₁ and T₂ based on the information of the number.

For example, in the case that the there are many times of number of retransmission of the data packet received after the relay function is activated, the value of T₁ may be changed greater than before, and the value of T₂ may be changed smaller than before.

On the other hand, in the case that the number of retransmission the data packet is small or that the data packet is not retransmitted, the value of T₁ may be changed smaller than before, and the value of T₂ may be changed greater than before.

That is, the value of T₁ and T₂ may be flexibly changed according to the number of retransmission.

The destination node that receives the data packet transmits ACK to the node in response to it (step, S12040).

The node receives the ACK within time T₂, and accordingly, the node transmits the ACK to the source node (step, S12050).

Since the source node knows that the data packet is transmitted to the destination node through receiving the ACK for the data packet, the source node does not retransmit the data packet.

In the case that the relay function is activated or deactivated in a Bluetooth mesh network through such a method, the time for activating or deactivating the relay function may be flexibly controlled.

That is in the case of the node that frequently transmits a data packet, it may be prevented the data packet from being unable to be transmitted to the destination node by elongating the activation time of the relay function, and in the case of the node that does not frequently transmit a data packet, the power consumption of the node and a repeated transmission of data packet may be decreased by decreasing the activation time of the relay function.

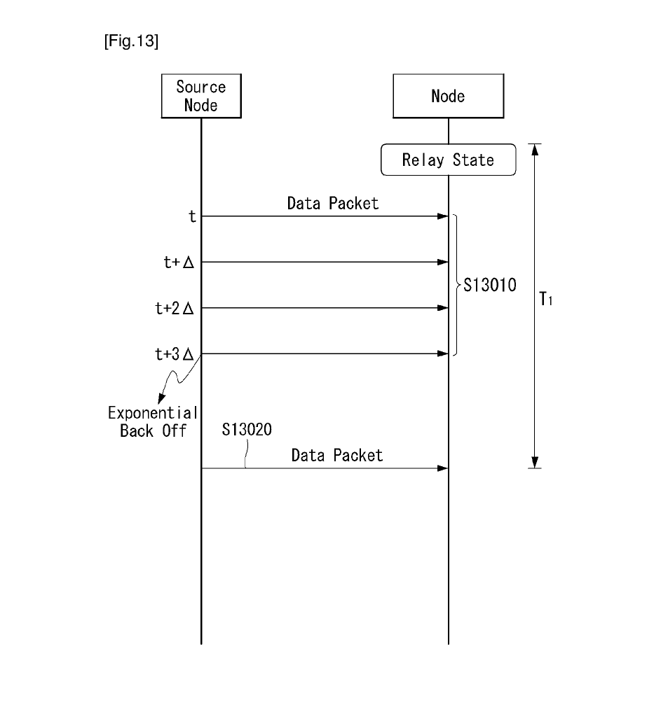

FIG. 13 is a flowchart illustrating an example of a method for changing a transmission period of data packet according to the number of retransmission in a Bluetooth mesh network to which the present invention is applicable.

Referring to FIG. 13, in the case that a source node retransmits a data packet with a predetermined period, the source node may change the retransmission period of the data packet if the source node fails to receive the ACK in response to it even though the source node retransmits the data packet for more than a predetermined number.

Particularly, the source node transmits the data packet to an adjacent node on time t. However, in the case that the relay function of the node is deactivated during time T₁, that is, in the case that the node plays the role of relay ready or is in the ready state, the node may not receive nor relay the data packet.

Accordingly, since the data packet transmitted on time t is not transmitted to a destination node, the source node is unable to receive the ACK for the data packet.

Since the source node is unable to receive the ACK within a predetermined time, the source node may retransmit the data packet on every specific period.

For example, in the case that the source node fails to receive the ACK within a predetermined time after the source node transmits the data packet, the source node retransmits the data packet to the node after time A.

However, the node is not able to receive nor relay the retransmitted data packet since the relay function of the node is deactivated during time T₁.

In the case that the source node is unable to receive the ACK, the source node retransmits the data packet on the period of A.

However, in the case that the source node is unable to receive the ACK for the data packet even though the source node retransmits the data packet for more than a predetermined number of times, the source node may change the value of A that represents a retransmission period.

For example, in the case that the source node is unable to receive the ACK for the data packet since the relay function of the node is deactivated even though the source node retransmits the data packet three times (step, S13010), the source node may elongate the transmission period of the data packet by using an Exponential Back Off.

Later, the source node may retransmit the data packet to the node according to the elongated transmission period (step, S13020).

In this case, the time in which the relay function is activated is the same or longer than the predetermined period, and the time in which the relay function is deactivated is shorter than the time when the data packet is retransmitted during the predetermined number of times.

For example, in the case that the time in which the relay function is deactivated is T₁, the specific period is A and the predetermined number is n, the relationship represented by Equation 1 below is established among T₁, Δ and n.

T₁<nΔ [Equation 1]

In addition, in the case that the time in which the relay function is deactivated is T₂, the relationship represented by Equation 2 below is established between T₂ and Δ.

T₂≧Δ[Equation 2]

Through the relationship as represented by Equation 1 and Equation 2, the node receives the data packet once at least from the source node.

Through the method, the probability that the data packet transmitted by the source node is dropped may be decreased, and the power consumption of the source node may be decreased by decreasing the retransmission number of the data.

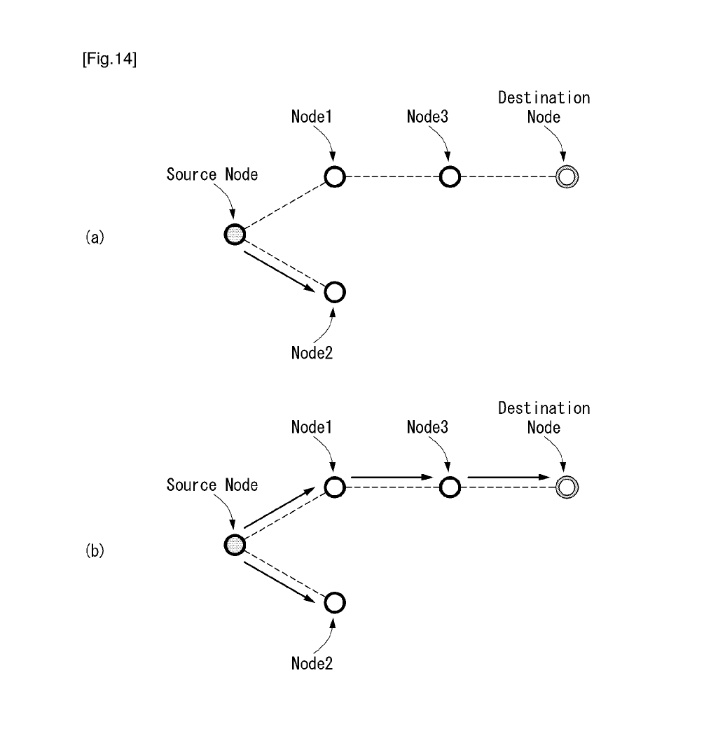

FIG. 14 is a view illustrating an example of a method for increasing the activation time of the relay function of a node in a Bluetooth mesh network to which the present invention is applicable.

Referring to FIG. 14, the activation time of the relay function may be increased through the method described in FIG. 12.

Particularly, the nodes that may initially perform the relay function in a Bluetooth mesh network are existed in the state of relay role or in the state of relay.

Later, in the case that the relay function of node 1 is deactivated after an arbitrary time, as shown in FIG. 14A, only node 2 may receive or retransmit the data packet transmitted by a source node.

However, since there is no destination node within the transmission range of the node 2, the data packet is not transmitted to the destination node.

Accordingly, since the source node is unable to receive ACK for the data packet, the source node retransmits the data packet.

Later, as shown in FIG. 14B, the relay function of the node 1 is activated after time T₁, and the relay function is maintained for time T₂.

While the relay function of the node is activated, the source node may transmit the data packet to the destination node through the node 1, and receive the ACK for it.

In this case, the node 1 may know that the data packet is retransmitted several times through the information of transmission number of the data packet which is received from the source node.

Accordingly, since the data packet is retransmitted several times, the node 1 may decrease the value of T₁ and increase the value of T₂.

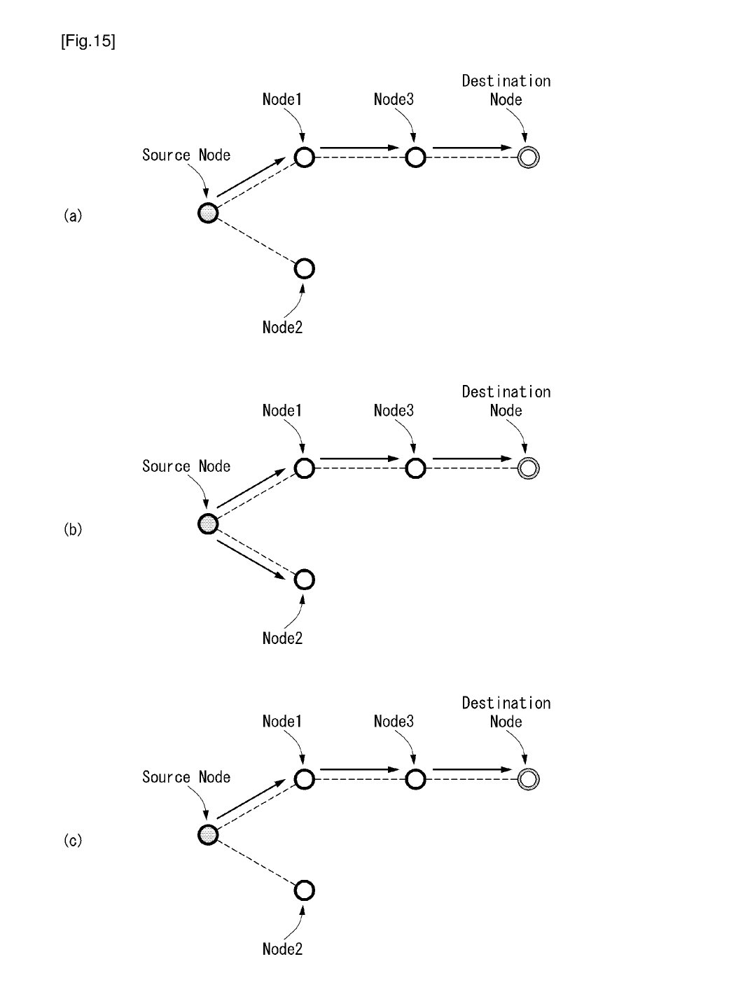

FIG. 15 is a view illustrating an example of a method for decreasing the activation time of a relay function of a node in a Bluetooth mesh network to which the present invention is applicable.

Referring to FIG. 15, the activation time of the relay function may be decreased through the method described in FIG. 12.

Particularly, the nodes that may initially perform the relay function in a Bluetooth mesh network are existed in the state of relay role or in the state of relay.

Later, even though the node 2 is unable to receive nor relay the data packet since the relay function of the node 2 is deactivated after an arbitrary time, the source node may transmit the data packet to the destination node through node 1 and node 3, and receive ACK in response to it, since the relay function of the node 1 and the node 3 are activated as shown in FIG. 15A.

Then, as shown in FIG. 15B, the relay function of the node 2 is activated after time T₁, and the relay function is maintained for time T₂.

Even though the node 2 receives the data packet from the source node since the relay function of the node 2 is activated, the node 2 is unable to transmit the received data packet to the destination node since the destination node is not existed within the transmission range of the node 2.

In addition, since the source node transmits the data packet through the node 1 and the node 3 even while the relay function of the node 2 is deactivated, the node 2 may know that the data packet is not retransmitted through the information of number of the data packet which is received after the relay function is activated.

Accordingly, since the data packet is not retransmitted, the node 1 may increase the value of T₁ but decrease the value of T₂.

As such, by increasing or decreasing the time when the relay function is activated and/or deactivated through the method described in FIG. 14 and FIG. 15, the data packet may be efficiently transmitted in the case that the data packet is transmitted through the flooding transmission technique in a Bluetooth mesh network.

The elements and the method described in the embodiments are not limitedly applied to the method described so far, but the whole or a part of each of the embodiments may be selectively constructed so as to form various modifications.

It will be apparent to those skilled in the art that various substitutions, modifications and variations can be made in the present invention described so far, without departing from the spirit or scope of the inventions by those skilled in the art, and therefore, the present invention is not limited to the described embodiments and the accompanying drawings.

The present disclosure relates to a transmission and reception of the Bluetooth data, and particularly, to a method and apparatus for transmitting a message between nodes in a mesh network using a Bluetooth Low Energy (LE) technique.

According to the method for transmitting and receiving data in a mesh network of the Bluetooth according to an embodiment of the present invention, there is an effect for a source node to transmit data to a destination node using the flooding technique through one or more nodes.

In addition, according to the present invention, by arbitrarily turning on or off the relay function of a part of the nodes that establish a Bluetooth mesh network, a data packet may be transmitted to a destination efficiently.

In addition, according to the present invention, by determining an activation time of the relay function of the nodes that establish a Bluetooth mesh network, the power consumption of each node may be decreased.

In addition, according to the present invention, by activating the relay function of the nodes of which number of retransmission is high among the nodes that establish a Bluetooth mesh network for a long time, the probability of the data packet being dropped may be decreased.

The technical effects in the present invention are not limited to the above-described technical effects and other technical effects which are not described herein will become apparent to those skilled in the art from the following description.

What is claimed is:

1. A method for transmitting and receiving a data packet in a Bluetooth mesh network performed by a node, comprising:
joining in the Bluetooth mesh network;
receiving a first data packet from a previous node in a relay state,
wherein the relay state is a state for relaying the data packet using flooding in the mesh network; and
transmitting the first data packet to at least one adjacent node,
wherein the first data packet includes number information indicating a number of retransmission of the first data packet,
wherein the relay state is maintained for a first specific time, and
wherein the first specific time is determined based on the number information.

2. The method of claim 1, further comprising,
receiving ACK in response to the first data packet from the at least one mode.

3. The method of claim 1,
wherein the at least one node is in a distance of 1 Hop from the node.

4. The method of claim 1,
wherein the first specific time increases as a value of the number information increases, and decreases as a value of the number information decreases.

5. The method of claim 1,
wherein the first data packet is repeatedly transmitted in every specific period, and
wherein the first specific time is a same as or greater than the specific period.

6. The method of claim 1, further comprising
changing the relay state to a ready state that does not transmit and receive data,
wherein the ready state is maintained for a second specific time.

7. The method of claim 6,
wherein the second specific time decreases as a value of the number information increases, and increases as a value of the number information decreases.

8. The method of claim 6,
wherein the second specific time is smaller than a maximum time that the first data packet is repeatedly transmitted with a specific period.

9. The method of claim 1,
wherein the node is changed to the ready state from the relay state after an random time, and
wherein the node is shifted to the relay state after a predetermined time.

10. A node for transmitting and receiving a data packet in a Bluetooth mesh network, comprising:
a communication unit for communicating to an exterior; and
a processor functionally connected to the communication unit,
wherein the processor is configured to:
join in the Bluetooth mesh network;
receive a first data packet from a previous node in a relay state, wherein the relay state is a state for relaying the data packet using flooding in the mesh network; and
transmit the first data packet to at least one adjacent node,
wherein the first data packet includes number information indicating a number of retransmission of the first data packet,
wherein the relay state is maintained for a first specific time, and
wherein the first specific time is determined based on the number information.
